(19) United States
(12) Patent Application Publication
(10) Pub. No.: US 2008/0084328 A1
(43) Pub. Date: Apr. 10, 2008

(54) Television remote Control Device

(76) Inventor: Catherine Crichton, New South Wales (AU)

Correspondence Address: BROWDY AND NEIMARK, P.L.L.C.;624 NINTH STREET, NW, SUITE 300, WASHINGTON, DC, 20001-5303, US

(21) Appl. No.: 11/813,630

(22) PCT Filed: Dec. 21, 2005
(86) PCT No.: PCT/AU05/01946

§ 371 Date: Jul. 10, 2007

(30) Foreign Application Priority Data
Jan. 10, 2005 (AU) 2005900096

(51) Int. Cl. G09B 21/00

(52) U.S. Cl. 340/825.19

(57) ABSTRACT

There is disclosed a remote control unit comprising a body having a user interface for receiving a command from a user. The body also comprises a controller for generating and transmitting one or more control signals for remotely controlling an electronic device in response to said command; and one or more handles attached to said body, each handle having an aperture through which the user grips the unit.

### CROSS-REFERENCE TO RELATED APPLICATIONS

The present application claims priority from Provisional Patent Application No 2005900096 filed on 10 Jan. 2005, the contents of which is incorporated herein by reference.

### TECHNICAL FIELD

The present invention relates generally to a remote control unit for remotely controlling an electronic device. In particular, the present invention relates to a remote control unit for remotely controlling an electrical component of an entertainment system, such as a television or stereo system that is easy to handle and operate, particularly by those individuals suffering from debilitating conditions, such as arthritis or visual impairment.

### BACKGROUND OF THE INVENTION

The use of remote control units in conjunction with electronic equipment is widespread. For televisions, stereos, video recorders and other related equipment, a large majority of all such devices sold today include a remote control unit for performing remote programming and control of the device.

Most remote control units are typically configured to only operate the specific equipment with which it is provided, and as such it is common for most households to have a variety of remote control units for controlling the operation of a variety of equipment. In this regard, such units are typically configured to perform multiple control functions and as such they are often intricate devices comprising a variety of buttons, each of which can perform one or more different functions.

With the current trend towards miniaturising electronic components such as remote control units, whilst the size of the unit has greatly reduced, the functionality of the unit has typically increased; resulting in small units comprising a myriad of closely spaced and minutely labelled buttons. In this regard, as well as requiring much finger dexterity to perform the desired control function, such units are typically of a size whereby they are readily misplaced or hidden under or within objects, which is frustrating for the user.

For elderly people or those suffering from visual impairment (particularly macular degeneration), arthritis, early dementia, Parkinson's disease, Multiple Sclerosis, or learning difficulties etc., the simple use of a remote control unit to operate a television or the like is often beyond their capabilities. Not only are the units of a size that is difficult to locate in the home environment and complex to operate, they are also typically difficult to grasp and manipulate. This is generally because conventional remote control units are provided in a long and flat rectangular housing, which is difficult to pick-up from a planar surface such as a table or the like, particularly for those individuals suffering from conditions such as arthritis, who have reduced finger dexterity.

As such, there exists a need to provide a remote control unit for controlling an entertainment device, such as a television, which is of a size and shape that is easy to grasp and locate, and which provides simple and effective control of the device.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to a first aspect, the present invention is a remote control unit comprising: a body having a user interface for receiving a command from a user, and a controller for generating and transmitting one or more control signals for remotely controlling an electronic device in response to said command; and one or more handles attached to said body, each handle having an aperture for receiving at least a portion of the user's hand to facilitate gripping of the unit.

In an embodiment of this aspect, each handle extends from the body. Each handle may be formed integral with the body and a portion of each handle may comprise a material which facilitates gripping of the handle. In this regard, the material may be a rubber material or other suitable non-slip material.

In one form, the fingers of the user's hand may be received within the aperture to facilitate gripping of the unit. In this regard, two handles may be attached to the body such that the user can grip the unit with both hands.

In another embodiment, the body has a base for supporting the remote control unit on a substantially planar support surface, such as a table or lap of the user. The base may support the unit on the support surface such that the body and the one or more handles are inclined at an angle to the support surface. In this regard, the base may comprise a projection that extends therefrom and contacts the support surface, thereby causing the body and the one or more handles to be inclined at an angle to the support surface. The angle of inclination of the body and the one or more handles to the support surface may be between about 10 and 70°, preferably between about 10° to 30°, more preferably about 17°.

In yet another embodiment, the user interface is provided on a surface of the body. The user interface may be provided on an upwardly facing surface of the body. In this regard, the upwardly facing surface of the body may be inclined to the support surface to facilitate use of the user interface. The user interface may have a surface area of between 15000 and 30000 mm², preferably about 17500 mm².

In one embodiment, the user interface is a keypad comprising one or more buttons for receiving commands from the user to remotely control the electronic device. Each button may be raised from the surface of the keypad. Each button may also have distinctive lighting or markings to aid in identifying and selecting the button. The keypad may be in the form of an insert which is received by the body.

According to a second aspect, the present invention is a remote control unit comprising:

a body having a base for supporting the unit on a support surface, a user interface for receiving a command from a user, and a controller for generating and transmitting one or more control signals for remotely controlling an electronic device in response to said command; and

one or more handles attached to said body to facilitate gripping of the unit by said user,

wherein said base is configured to support said unit in an inclined position on said support surface such that at least a portion of said one or more handles are raised from said support surface.

### BRIEF DESCRIPTION OF THE DRAWINGS

By way of example only, preferred embodiments of the invention are now described with reference to the accompanying drawings, in which:

FIG. 1 is a front perspective view of the remote control unit according to one embodiment of the present invention;

FIG. 2 is a rear perspective view of the remote control unit of FIG. 1;

FIG. 3 is a side view of the remote control unit of FIG. 1;

FIG. 4 is a rear view of the remote control unit of FIG. 1;

FIG. 5 is an exploded view of the remote control unit of FIG. 1, prior to assembly of the unit;

FIG. 6 is a top perspective view of an alternative embodiment of a remote control unit in accordance with the present invention;

FIG. 7 is a bottom perspective view of the remote control unit of FIG. 6;

FIG. 8 is a top view of the remote control unit of FIG. 6;

FIG. 9 is a side view of the remote control unit of FIG. 6;

FIG. 10 is an end view of the remote control unit of FIG. 6;

FIG. 11 is a top perspective view of the remote control unit of FIG. 6 with drawer element in an open position for replacing batteries; and

FIG. 12 is a bottom perspective view of FIG. 11.

### PREFERRED MODE FOR CARRYING OUT THE INVENTION

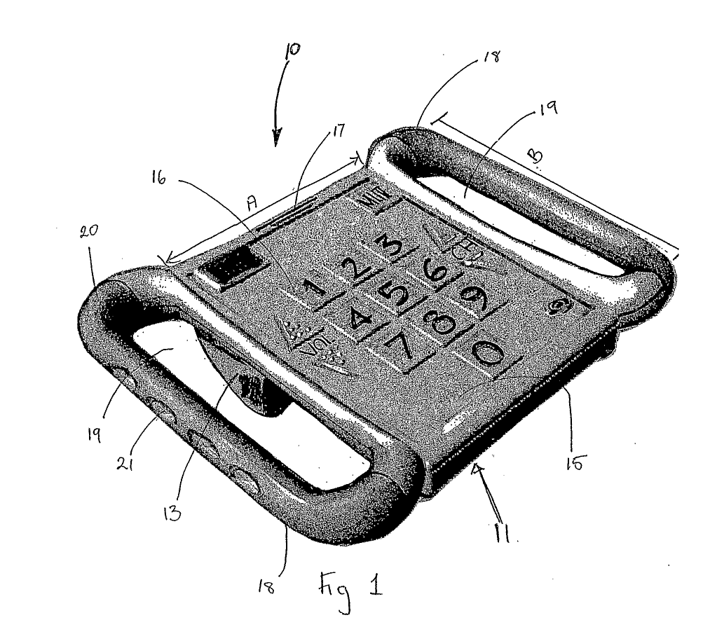

One embodiment of a remote control unit 10 is shown generally with regard to FIGS. 1 to 5. It will be appreciated that the remote control unit 10 is intended to be used as a universal remote control unit suitable for use with a variety of different types of electrical devices, such as televisions or the like. As a result, the invention resides in the configuration of the remote control unit, and not in the manner in which the remote control unit processes information and receives and transmits control signals, all of which are considered well known in the art and not discussed in any further detail below.

The unit 10 comprises a main body 11 that houses the power supply and controller, namely the control circuitry of the unit for remotely controlling the associated electrical device. In this regard, the main body 11 is in the form of an enclosed, substantially rectangular box having a width A of approximately 110 mm, a length B of approximately 160 mm.

The main body 11 has a base portion 12 for supporting the unit 10 on a substantially planar surface, such as the surface of a table or chair, or the lap of the user. A projection 13 is provided on the base portion 12 adjacent an edge thereof, such that, when the unit 10 is supported on the substantially planar support surface, the main body 11 is inclined with respect to the support surface, to facilitate easy use and handling of the unit 10. The angle at which the main body 11 is inclined from the support surface, and hence the configuration of the projection 13, may vary. In one form the projection 13 may be configured to provide an angle of inclination of the main body of between 10-70°. In the unit as shown in each of the figures, the angle of inclination of the main body is approximately 17°. The projection 13 may be formed integral with the base portion 12 of the main body 11, and in this regard, the projection 13 may accommodate batteries or other internal componentry therein, in a manner which will be described in more detail below.

To provide stability to the unit 10 in the inclined position with respect to the support surface, a gripping element 14 is provided on the surface of the projection 13 which contacts the substantially planar support surface. The gripping element 14 is in the form of a rubber pad or other type of non-slip surface, which is attached to the projection 13 via an adhesive. To further stabilise the unit 10 in the inclined position, additional gripping elements 14 are also provided on the base portion 12 of the main body 11, as shown in FIG. 3. The additional gripping elements 14 may also be in the form of rubber or other type of non-slip pads which are attached to the base portion 12 at the point of contact with the support surface. In the embodiment as shown, this point of contact is adjacent the front edge of the main body 11.

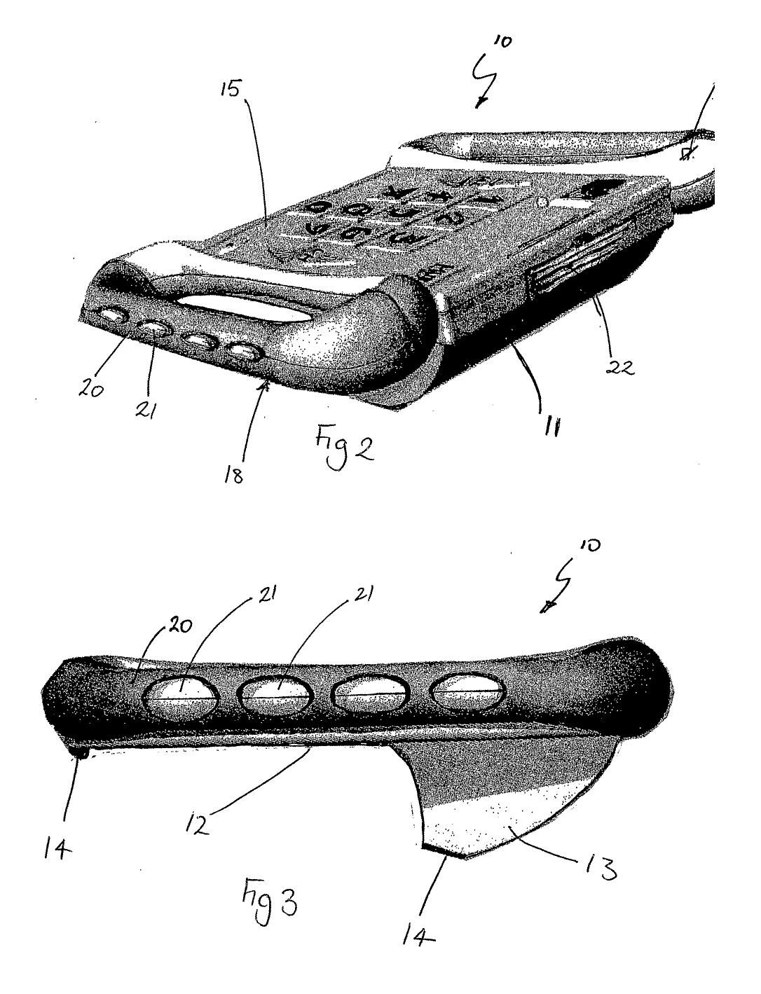

As shown more clearly in FIGS. 1 and 2, the upwardly facing surface of the main body 11 includes a user interface portion 15 for receiving control commands from a user for remotely controlling the associated electrical device. The user interface portion 15 is in the form of a keypad insert which is received by the main body 11 and which extends substantially across the upwardly facing surface of the main body 11. The keypad insert is made from a rubber or other type of resiliently flexible material and has one or more control buttons 16 provided on its surface.

The control buttons 16 may be formed integral with the keypad insert of the user interface portion 15, or may be separate and received within shaped recesses provided in the keypad insert. In any regard, each of the control buttons 16 are provided such that they can each move independently of the keypad insert of the user interface portion 15, should any one of the buttons 16 be depressed by the user. Each of the control buttons 16 are therefore arranged to extend above the surface of the interface portion 15 such that they can be simply depressed to register a control action from the user. In this regard, the buttons may extend approximately 2 mm above the surface of the user interface portion 15.

The control action of the user is registered due to each of the control buttons 16 being arranged to communicate with an associated electrical switch or the like provided in the control circuitry of the unit 10, stored within the main body 11. Upon the depression of a specific control button 16, the underside of the button 16 closes a corresponding electrical switch, thereby sending an associated signal to the control circuitry of the unit 10. This signal in turn generates an associated command which is transmitted to the remote electrical device to control its operation.

As the user interface portion 15 of the unit 10 extends across a particularly large surface of the main body 11, the control buttons 16 are arranged in a manner which enables easy identification and selection of the desired buttons. This is particularly important especially for those individuals suffering from visual problems or an arthritic condition, who have difficulty differentiating between small, closely spaced buttons. In this regard, the user interface portion 15 generally has a surface area of between 15000-30000 mm², preferably around 17500 mm². As will be appreciated, the user interface portion 15 of the remote control unit 10 of the present invention is significantly larger than that which exists on existing remote control units used for remotely control televisions or the like. Further to this, due to the inclined nature of the main body 11 when the unit is placed upon a substantially planar support surface, the user interface portion 15 is angled to present the user with a keypad which is easy to view and simple to use.

As the surface area of the interface portion 15 is relatively large, particularly with regard to existing remote control devices, the spacing between neighbouring control buttons 16 and the size of the control buttons 16, can be optimised to provide easy identification and selection of the appropriate button to perform the desired user function. As will be appreciated, the control buttons may be arranged upon the surface of the user interface portion 15 in a variety of ways. However, in order to simplify the use of the unit, such that it can be readily used by the elderly and or physically or visually impaired, only the most essential control buttons 16 are provided on the user interface portion 15, such as volume control, channel selection and on/off button.

To further assist in selecting and operating the appropriate control button 16, each button is provided with large numbering or text, as well as back-lighting which aids in identifying the appropriate button. Further, each button 16 may illuminate when depressed to provide feedback to the user to indicate whether the desired button 16 was selected. Due to the large size of the control buttons 16, the texture of the buttons may vary to aid the visually impaired. In this regard, the texture of the buttons 16 that control the volume of the remote electrical device may have a different texture to those buttons 16 that control the channel selection of the remote electrical device. For instance, the numbered channel selection buttons may have raised numbers formed thereon to assist in easy recognition. It is also envisaged that the shape and/or colour of the buttons 16 may differ between buttons 16 responsible for performing different tasks.

The user interface portion 15 can provide a variety of additional functions to the user other than a conventional on/off function, volume control and channel selection. In this regard, the main body 11 may also have an inlet (not shown) into which a headset may be connected. Such an arrangement may be particularly beneficial for the elderly and provides a portable sound system which receives audio signals emitted from the electrical device. In this regard, the user may simply select an appropriate button provided on the user interface portion, by which sound emitting from the television set or the like may be muted and is delivered to the user through the headset. Similarly, the unit 10 may have speakers incorporated therein and retained within the main body 11 to deliver localised sound from the remotely positioned electrical device. In this regard, sound outlets 17, are provided in the main body 11 such that sound can be emitted from the unit 10, via internal speakers.

In this arrangement, the remote control unit 10 may also function as a telephone, allowing the user to answer incoming telephone calls received by an associated telephone unit. The remote control unit 10 may be programmed to communicate with the telephone unit to both transmit signals to, and receive signals from, the telephone unit. The user interface portion 15 may be provided with a telephone function button which can be selected by the user to enable the remote control unit to communicate with the associated telephone unit. Should the telephone unit receive a call, the user may select the telephone function button to answer the call. Upon answering the call the call may be transmitted to the remote control unit 10 where the sound of the caller's voice is emitted from the speakers or sound outlets 17, or through the headset to the user. Similarly a microphone (not shown) is provided to receive the user's voice and transmit the voice signal to the telephone unit and down the telephone line to provide the user with the ability to converse with the caller. The remote control unit 10 may also be used to make telephone calls and dial numbers through the numeric buttons on the user interface portion 15. Such an arrangement is particularly beneficial to the elderly and/or disabled, thereby allowing them to answer and use the phone through the same remote control device as used to control the television.

Another function that the remote control unit is able to perform is to communicate with a cable or pay television control unit to enable a user to have a universal remote control unit that controls both the free-to-air stations together with the pay-TV stations. In this regard, the user interface portion 15 may be provided with toggle button to allow the user to switch between the dual systems easily.

To communicate with the various remote electrical devices and transmit control signals therebetween, a conventional infrared sensor 23 is provided at the rear edge of the main body 11. In this regard, when the unit 10 is positioned for use on the user's lap or a table or other similar planar surface, the rear edge of the main body 11 is elevated such that the sensor 23 is raised above any obstructions which may prevent communication between the unit 10 and the remotely positioned electrical device.

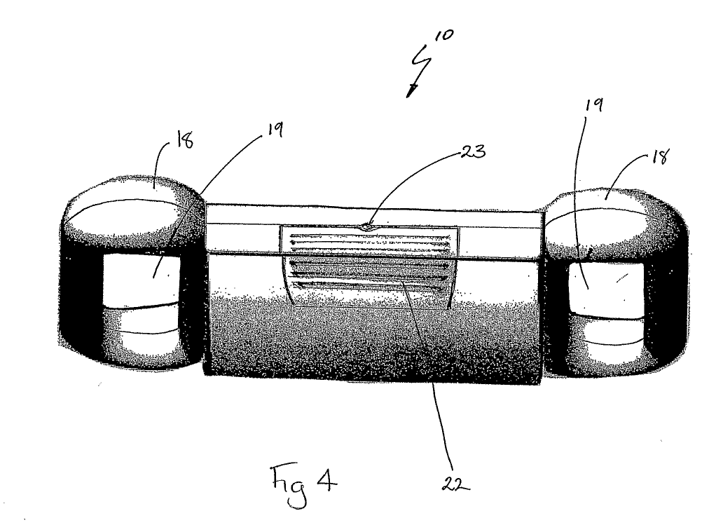

As discussed above, the remote control unit 10 is powered via replaceable or rechargeable batteries retained within the main body 11. As shown more clearly in FIG. 4, in order to facilitate ready replacement or recharging of such batteries, an access hatch 22 is provided at the rear edge of the main body 11 and projection 13. The hatch 22 is received in a removed portion of the main body 11 and projection 13 via an interference fit, which allows the hatch 22 to be slidably removed therefrom. By removing the hatch, the batteries can be received by the appropriate terminals provided within the internal space of the main body 11 and projection 13, to provide power to the electronics of the unit 10.

As is shown in each of the FIGS. 1 to 5, attached to the main body 11 of the unit 10, along opposing sides thereof, is a pair of handles 18. Each of the handles 18 extend along the length of the main body 11 and have a recess 19 provided therein. Each recess 19, is provided to receive part of the user's hand, such as the fingers, to enable the user to securely grip the handle. Therefore, even in the event of the user suffering from arthritis or the like which may restrict the amount of control and force by which they can grip a conventional remote control device, the user is able to firmly grasp the unit 10 with one or both hands.

Due to the fact that the main body 11 is inclined in relation to the support surface, the handles 18 are also raised from the support surface. As such, the user, does not need to firstly grip the unit 10 and raise the unit from the support surface to access the recess 19 of the handles, which may be a difficult task especially for those suffering from arthritis or the like. Rather, the handles 18 are maintained at an elevated position from the support surface and are presented to the user in a manner which enables the user to easily access the recess 19 to grip the handles 18 and use the unit.

The handles 18 have grip portions 20 made from a suitable rubber or non-slip material to aid in providing the user with a comfortable and stable surface to grip the unit. In this regard, the grip portions 20 may be provided with depressions 21 in the outer surface thereof to mould with the user's hand to aid in positioning the user's hands to facilitate gripping of the unit.

As the grip portions 20 are made from a suitable rubber material and extend outwardly from the main body 11, they also act to protect the unit 10 should the unit be accidentally dropped. In this regard, the handles 18 act as shock absorbers and absorb the contact forces of the unit hitting the ground, thereby reducing such forces being transferred to the electronics contained within the main body 11.

As shown more clearly in FIG. 5, the unit 10 is preferably constructed in a modular arrangement, with the pieces fitting together to form the assembled unit as shown in FIGS. 1 to 4.

The base component 25 comprises the base portion 12 of the main body 11, and a base portion of the handles 18 extending along opposing edges thereof. The base component 25 therefore resembles an open topped receptacle providing access to the internal cavity of the main body 11 and projection 13 to enable the control electronics and internal circuitry associated with the power source to be fitted and positioned for assembly. As shown, the user interface portion 15, in the form of a keypad insert, can then be appropriately positioned upon a circuit board associated with the control circuitry of the unit 10, such that depression of the buttons 16 will be registered by the control circuitry and an appropriate control signal generated and transmitted via the sensor 23.

The top component 26 is arranged to engage with the base component 25 via appropriate lugs (not shown) which extend therefrom and engage with corresponding recesses (not shown) provided in the base component 25. The top component 26 has a central recess portion which frames the user interface portion 15 positioned atop the base component 25, thereby securing the user interface portion 15 in position between the top component 26 and the base component 25. The snap-fitting engagement between the top component 26 and the base component 25 enables the unit 10 to be readily assembled/disassembled for manufacture or servicing.

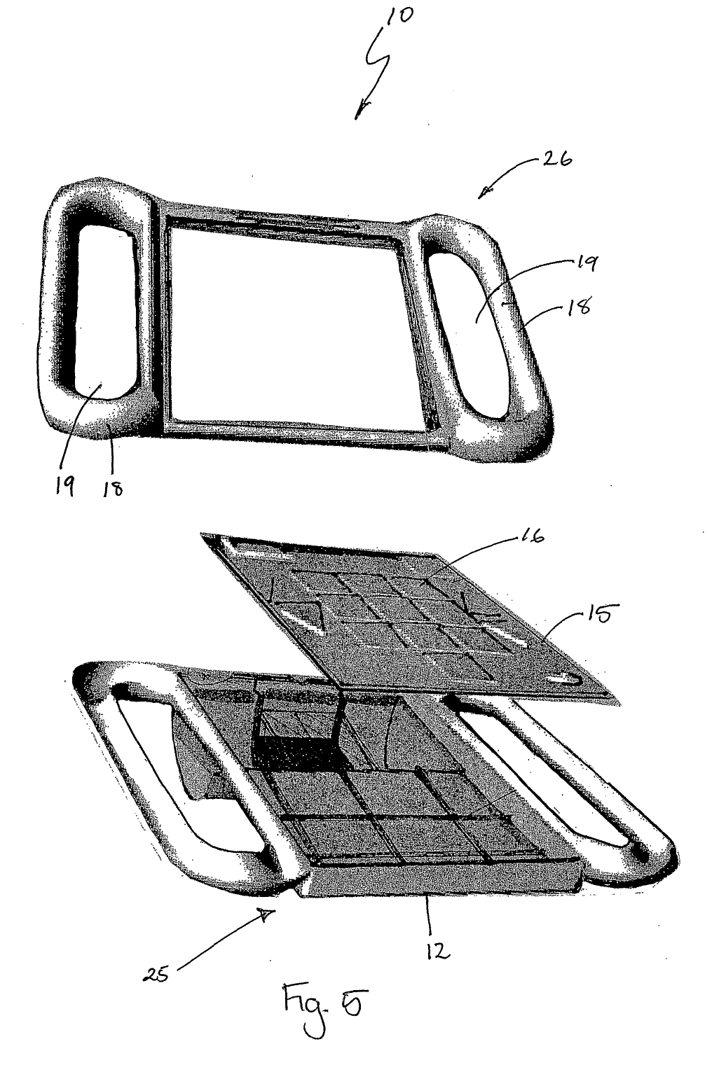

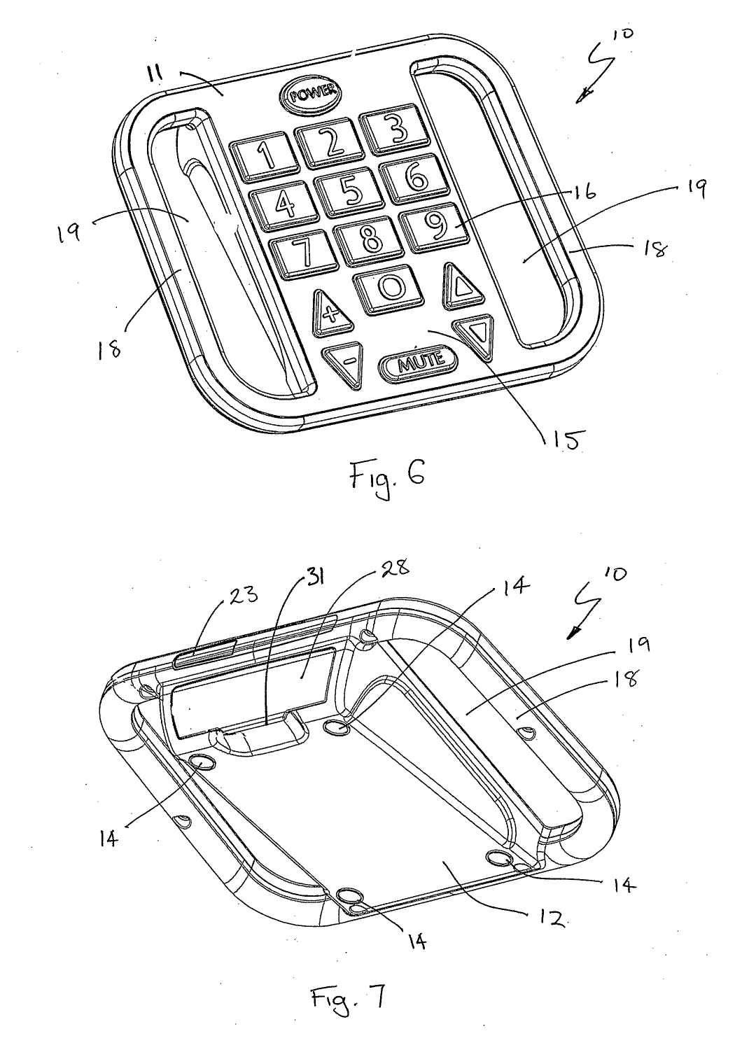

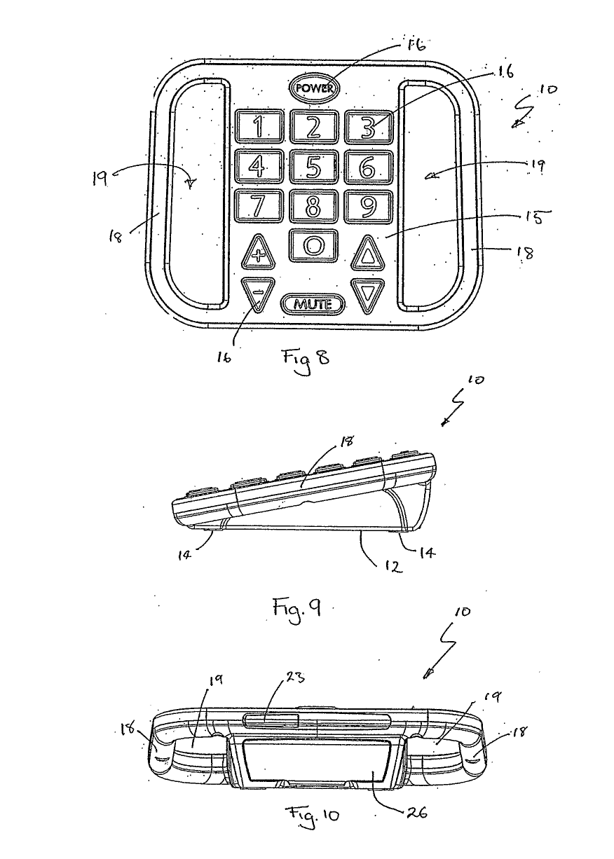

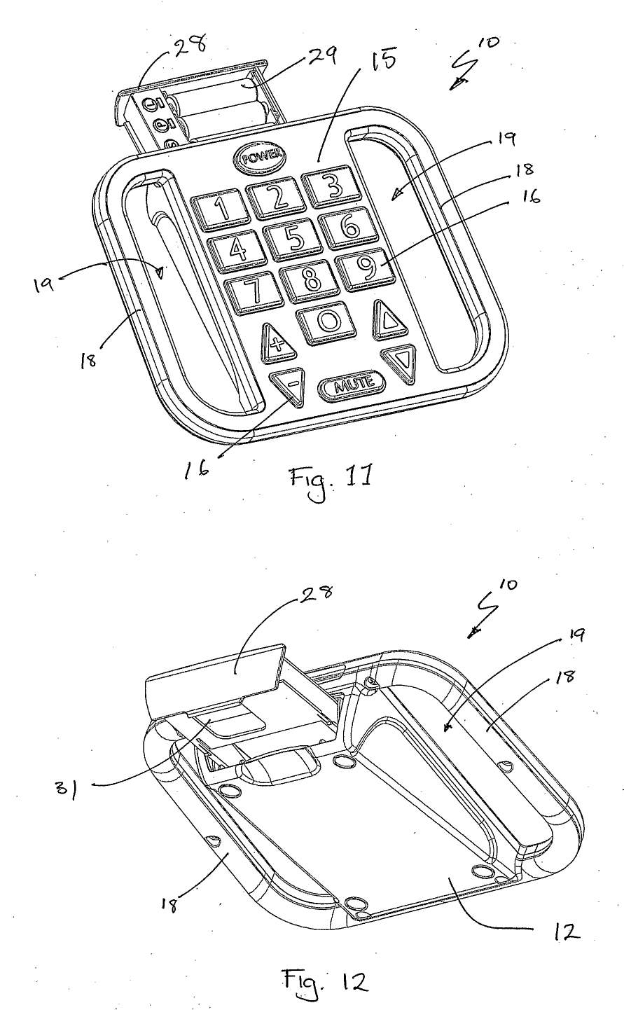

FIGS. 6 to 12 show an alternative embodiment of the remote control unit 10. In these figures the same reference numerals are used to represent the same or similar elements for clarity.

In the embodiment as shown in FIGS. 6 to 12, the remote control unit 10 has a base portion 12 which defines a substantially flat surface for contacting the support surface, such as a tabletop or a person's lap. This is shown more clearly in FIG. 7, as the base portion 12 has a plurality of gripping elements 14 arranged thereon to provide stability to the base portion 12.

As shown in FIG. 6, the user interface portion 15 differs slightly to that as shown in the embodiment of FIGS. 1 to 5. In this arrangement, the control buttons 16 are of a similar size and arrangement such that they can be easily recognised and accessed by the user. It will be appreciated that as is shown in both of the described embodiments, the manner in which the control buttons 16 are arranged on the user interface portion 15 can vary depending upon the requirements of the user.

Further, as shown in FIGS. 10 to 12, rather than the hatch 22 of the embodiment of FIGS. 1 to 5, the batteries 29 may be retained within a drawer element 28 slidably retained within the main body 11. To remove or replace the batteries 29, the user simply grips the recess 31 provided in the underside of the drawer element 28 and slides the drawer element 28 from the main body 11. Upon replacement of the batteries 29, the drawer element 28 can be slid into position such that it is fully retained within the main body 11 to provide operating power to the unit 10.

The remote control unit 10 of the present invention provides a simple, large, easy to operate and relative inexpensive device for remotely controlling a television or other similar electrical equipment. The remote control unit achieves this by presenting to the user clearly defined and tactile buttons, substantially free of surplus functions, in a form which can readily be gripped and manipulated by the user to provide stability to enable the user to confidently use the device to achieve the desired outcome.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A remote control unit comprising:
body having a user interface for receiving a command from a user, and a controller for generating and transmitting one or more control signals for remotely controlling an electronic device in response to said command; and
one or more handles attached to said body, each handle having an aperture through which the user grips the unit.

2. The remote control unit of claim 1, wherein the or each handle extends from the body.

3. The remote control unit of claim 1, wherein the or each handle IS formed integral with the body.

4. The remote control unit of claim 1, wherein a portion of the handle comprises a material which facilitates gripping of the handle.

5. The remote control unit of claim 4, wherein the material is a non-slip material, such as a rubber or plastics material.

6. The remote control unit of claim 1, wherein the aperture of the or each handle is configured to receive at least a portion of the user's hand.

7. The remote control unit of claim 6, wherein the aperture of the or each handle is configured to receive the fingers of the user's hand.

8. The remote control unit of claim 1, wherein two handles are attached to the body such that the user grips the unit with both hands.

9. The remote control unit of claim 1, wherein the body has a base for supporting the remote control unit on a substantially planar support surface.

10. The remote control unit of claim 9, wherein the base supports the remote control unit on the support surface in a manner such the one or more handles are raised from said support surface.

11. The remote control unit of claim 10, wherein the one or more handles are raised such that they are inclined at an angle to the support surface.

12. The remote control unit of claim 9, wherein the base comprises a projection that extends therefrom and contacts the support surface, thereby causing the body and the one or more handles to be inclined at an angle to the support surface.

13. The remote control unit of claim 11, wherein the angle of inclination of the body and the one or more handles to the support surface is between about 10° and 70°.

14. The remote control unit of claim 13, wherein the angle of inclination is between about 10° and 30°

15. The remote control unit of claim 14, wherein the angle of inclination is about 17°.

16. The remote control unit of claim 1, wherein the user interface is provided on a surface of the body.

17. The remote control unit of claim 16, wherein the user interface is provided on an upwardly facing surface of the body.

18. The remote control unit of claim 17, wherein the upwardly facing surface of the body is inclined to a support surface to facilitate use of the user interface by a user.

19. The remote control unit of claim 1, wherein the user interface is a keypad.

20. The remote control unit of claim 19, wherein the keypad comprises one or more buttons for receiving commands from a user to remotely control the electronic device.

21. The remote control unit of claim 20, wherein each button is raised from the surface of the keypad.

22. The remote control unit of claim 21, wherein each button has distinctive lighting and/or markings to aid in identifying and selecting the button.

23. The remote control unit of claim 20, wherein the keypad is in the form of an insert which is received by the body.

24. The remote control unit of claim 1, wherein the user interface has a surface area of between about 15000 mm² and 30000 mm2

25. The remote control unit of claim 24, wherein the user interface has a surface area of about 17500 mm2.

26. A remote control unit comprising:
a body having a base for supporting the unit on a support surface, a user interface for receiving a command from a user, and a controller for generating and transmitting one or more control signals for remotely controlling an electronic device in response to said command; and
one or more handles attached to said body to facilitate gripping of the unit by said user,
wherein said base is configured to support said unit in an inclined position on said support surface such that at least a portion of said one or more handles are raised from said support surface.
